(19) United States
(12) Patent Application Publication
(10) Pub. No.: US 2010/0026519 A1
(43) Pub. Date: Feb. 4, 2010

(54) METHOD OF DETECTING AND SIGNALING DEVIATTION OF MOTOR VEHICLE

(76) Inventors: WEI-CHUAN HSIAO, Hsinchu City (TW); Tsung-YING Lin, Taichung City (TW); Jui-Ping Wu, Tantzu (TW)

Correspondence Address: LEONG C LEI, PMB # 1008, 1867 YGNACIO VALLEY ROAD, WALNUT CREEK, CA, 94598, US

(21) Appl. No.: 12/182,138

(22) Filed: Jul. 30, 2008

(51) Int. Cl. G08G 1/09

(52) U.S. Cl. 340/905

(57) ABSTRACT

The present method first provides an image capturing device so that the image obtained by the image capturing device contains only dark-colored road paving and a light-colored lane marker appearing in the left or right portion of the image. The present method then determines the distribution of the light-colored pixels in each consecutive image captured. When the distribution of the light-colored pixels is shifted towards the other side of the images, the motor vehicle is assumed to be deviating from its current traveling lane. When the distribution of the light-colored pixels conforms to a terminal condition, the present method provides at least an audible alarm such as a siren or a pre-recorded voice message to alert the driver.

### BACKGROUND OF THE INVENTION

1. Field of the Invention

The present invention generally relates to methods to enhance driving safety, and more particularly to a method of detecting a motor vehicle's deviation from its current traveling lane and producing alarm to alert the driver.

2. Description of Related Art

Systems and methods to assist drivers and to prevent them from accidents under the influence of alcohol or weariness are constantly researched and developed by industry and academia. Recently, there is a trend in utilizing image processing techniques to recognize lane markers and to alert the driver when the motor vehicle deviates its current traveling lane.

For example, U.S. Pat. No. 5,530,420 teaches a running guide apparatus which utilizes two cameras and their captured images to determine the locations of the lane markers. U.S. Pat. No. 6,489,887 teaches a system containing, in addition to a camera, a yaw rate sensor to determine the relationship between a deviation angle of the motor vehicle and the curvature of its traveling lane. In addition, Republic of China, Taiwan, Patent No. I2280876 uses a single camera and special image processing method to detect the abnormal deviation of the motor vehicle. This method requires a “search area” to be defined before hand. Then, if lane markers cannot be located in the search area, an alarm would be generated.

These prior arts has one thing in common, which they all try to determine the two lane markers at either side of the motor vehicle. Then, an alarm is triggered when abnormal change to the two lane markers. As could be understood, the solutions disclosed by these teachings based on the perspective of the driver or the motor vehicle, and they have the following common drawbacks. First, in rainy days or when there is not enough lighting or the lane markers do not have some reflection means, it would be quite difficult to precisely locate the lane markers. Secondly, the prior arts usually require two cameras and therefore a higher cost. In addition, since these prior arts' algorithms are rather complicated, a more powerful vehicle computer is required for image processing, adding even more cost.

### BRIEF SUMMARY OF THE INVENTION

Accordingly, a novel, effective, simple, and inexpensive method is provided herein to obviate the foregoing shortcomings of the prior arts.

The present method first provides an image capturing device. In one embodiment of the present invention the image capturing device is installed at a head portion of a motor vehicle substantially in front of either the left front wheel or the right front wheel so that the image obtained by the image capturing device contains only dark-colored road paving and a light-colored lane marker appearing in the left or right portion of the image.

The present method then determines the distribution of the light-colored pixels in each consecutive image captured. When the distribution of the light-colored pixels is shifted towards the other side of the images (i.e., the number or density of the light-colored pixels increases within the other side), the motor vehicle is assumed to be deviating from its current traveling lane. When the distribution of the light-colored pixels conforms to a terminal condition, the present method provides at least an audible alarm such as a siren or a pre-recorded voice message to alert the driver.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1a is a schematic diagram showing an exemplary installation of the image capturing device according to an embodiment of the present invention.

FIG. 1b is a schematic diagram showing an exemplary image obtained by the image capturing device of FIG. 1a.

FIG. 2a is a schematic diagram showing an exemplary distribution of light-colored pixels according to a first embodiment of the present invention when the motor vehicle runs normally within its traveling lane.

FIG. 2b is a schematic diagram showing an exemplary distribution of light-colored pixels according to a first embodiment of the present invention when the motor vehicle deviated to its right side.

FIG. 2c is a schematic diagram showing an exemplary distribution of light-colored pixels according to a first embodiment of the present invention when the motor vehicle deviated to its left side.

FIG. 3a is a schematic diagram showing an exemplary distribution of light-colored pixels according to a second embodiment of the present invention when the motor vehicle runs normally within its traveling lane.

FIG. 3b is a schematic diagram showing an exemplary distribution of light-colored pixels according to a second embodiment of the present invention when the motor vehicle deviated to its right side.

FIG. 3c is a schematic diagram showing an exemplary distribution of light-colored pixels according to a second embodiment of the present invention when the motor vehicle deviated to its left side.

FIG. 4 is a schematic diagram showing an exemplary installation of the image capturing device according to another embodiment of the present invention.

### DETAILED DESCRIPTION OF THE INVENTION

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

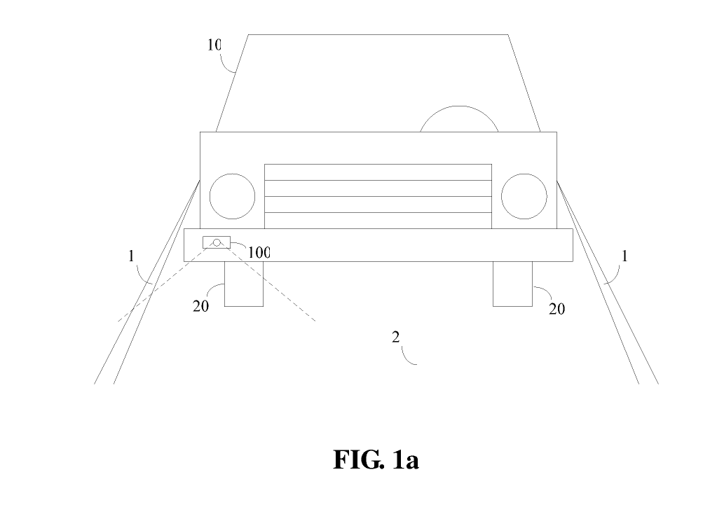

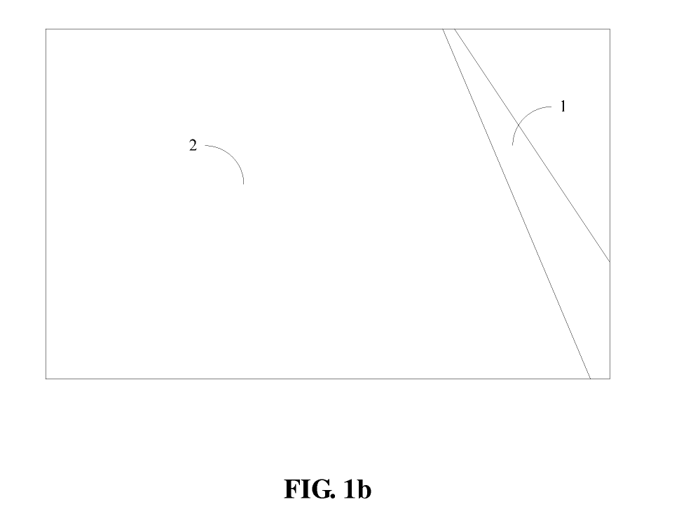

The present invention also relies on image processing to determine the deviation of a motor vehicle but it requires only a single image capturing device (i.e., camera), in contrast to some of the prior arts. In one embodiment of the present invention, as shown in FIG. 1a, the image capturing device 100 is installed on a head portion of a motor vehicle 10 substantially in front of the right front wheel's tire 20. FIG. 1b shows an exemplary image obtained by the image capturing device 100. Usually, lane marker 1 is painted white or yellow on the dark-colored road paving 2 and therefore, as long as there is enough illumination, the two's contrast is obvious. The image capturing device 100 and its field of view (denoted by the dashed lines) should be arranged so that the light-colored lane marker 1 appears only in a right portion of the captured image.

The present method is usually implemented as firmware or software of a computing device (not shown), which could be the motor vehicle's built-in car computer or a separate and dedicated computer. In some embodiment, the image capturing device 100 and the computing device could be integrated together as a single device and installed in the head portion of the motor vehicle. The power required by the computing device and the image capturing device 100 is obtained from the motor vehicle's own electrical system. In the following, the image capturing device 100 and the computing device are assumed to be separate devices.

The images obtained by the image capturing device 100 are delivered to the computing device via appropriate cabling and processed according to the present invention. The prior arts generally try to identify or recognize the curve or line representing the lane marker. These approaches inevitable require considerable computing resource. In contrast, the present method teaches a relatively simplified approach requiring only limited computation. Using FIG. 1b as example, when the light-colored block of the lane marker is detected to be shifting from its originally located right portion to the other portion in consecutive images obtained by the image capturing device 100, the motor vehicle is assumed to be deviating.

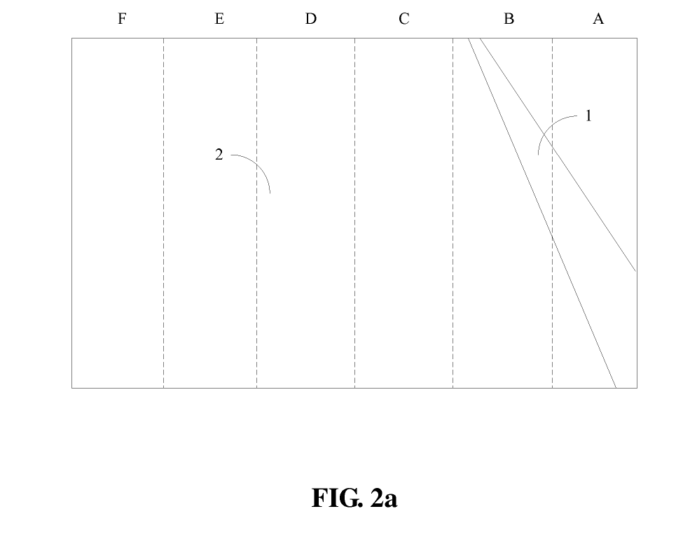

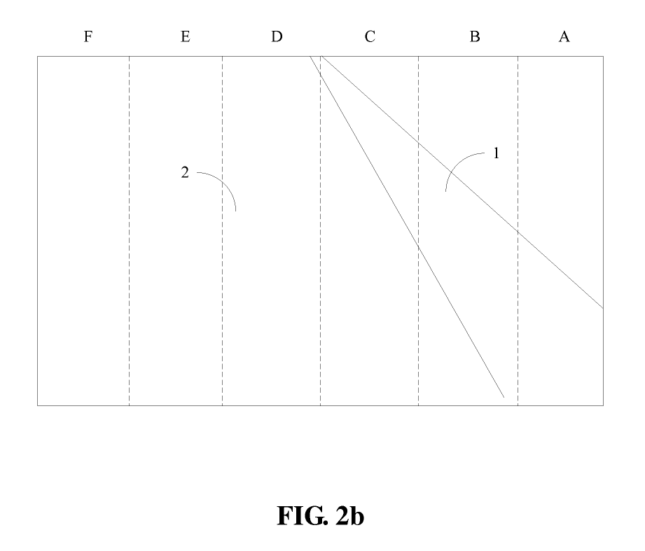

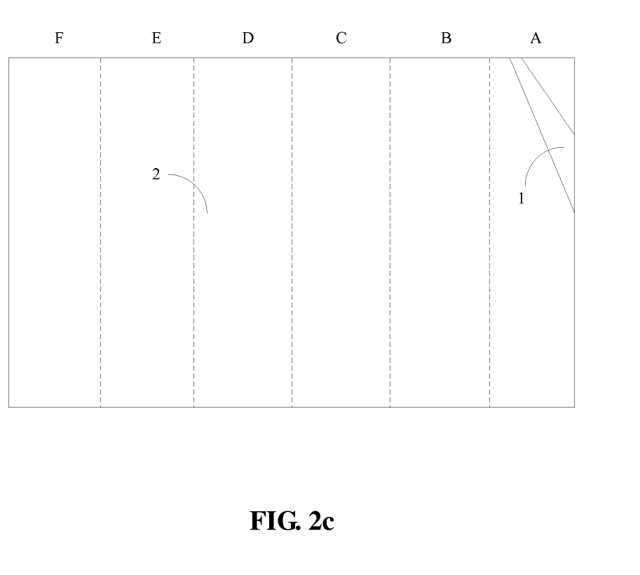

The “shifting” of the light-colored block could be determined in various ways. In one embodiment of the present invention, which is illustrated in FIGS. 2a˜2c, each image obtained by the image capturing device 100 is partitioned laterally to regions A to F of equal size (i.e., these regions contain a same number of pixels). The density D of light-colored pixels (i.e., pixels having a brightness above a specific level) within each region is then calculated by D=P_{white}/Pₜₒₜₐₗ, where is the number of light-colored pixels P_{white} in a region and Pₜₒₜₐₗ is the total number of pixels in that region. In the following, D_{A}, D_{B}, . . . , D_{F} refer to the densities of the light-colored pixels in regions A to F, respectively.

When the motor vehicle is driven steadily within its traveling lane, the densities D_{A}, D_{B}, . . . , D_{F} should remain substantially un-changed. Even though there is some variation, the variation should be insignificant or temporal. For example, under normal driving condition, D_{C}, D_{D}, D_{E}, D_{F} should all be close to zero while D_{A}, D_{B} are close to two non-zero constants. When the driver is dozy or not sober and the motor vehicle slips to the right, an exemplary image obtained by the image capturing device 100 is illustrated in FIG. 2b. As can be expected, if the motor vehicle continues to deviate to its right side, not only D_{A}, D_{B} will continue to increase, D_{C}, D_{D}, D_{E}, etc. will start to increase sequentially one by one. In other words, this simple trend of density variation reflects a possible deviation of the motor vehicle. Then, as the trend has reached a certain terminal condition, the deviation to the right is certain and has become dangerous. There are also various ways to design the terminal condition. The following are some examples. A terminal condition is (D_{C}≧T_{C}), where T_{C} is a threshold value. Another terminal condition is (D_{C}≧T_{C}) and the speed of the motor vehicle is not zero. Yet another terminal condition is (D_{C}≧T_{C}), the speed of the motor vehicle is not zero, and the previous two states are maintained for a period of time.

When the motor vehicle slips to the left, an exemplary image obtained by the image capturing device 100 is illustrated in FIG. 2c. As can be expected, if the motor vehicle continues to deviate to its left side, first D_{B} will start to decrease, and then D_{A} will start to decrease as well. Again, there are also various ways to design the terminal condition. The following are some examples. A terminal condition is (D_{A}≦T_{A}, D_{B}≦T_{B}), where T_{A}, T_{B} are threshold values. Another terminal condition is (D_{A}≦T_{A}, D_{B}≦T_{B}) and the speed of the motor vehicle is not zero. Yet another terminal condition is (D_{A}≦T_{A}, D_{B}≦T_{B}), the speed of the motor vehicle is not zero, and the previous two states are maintained for a period of time.

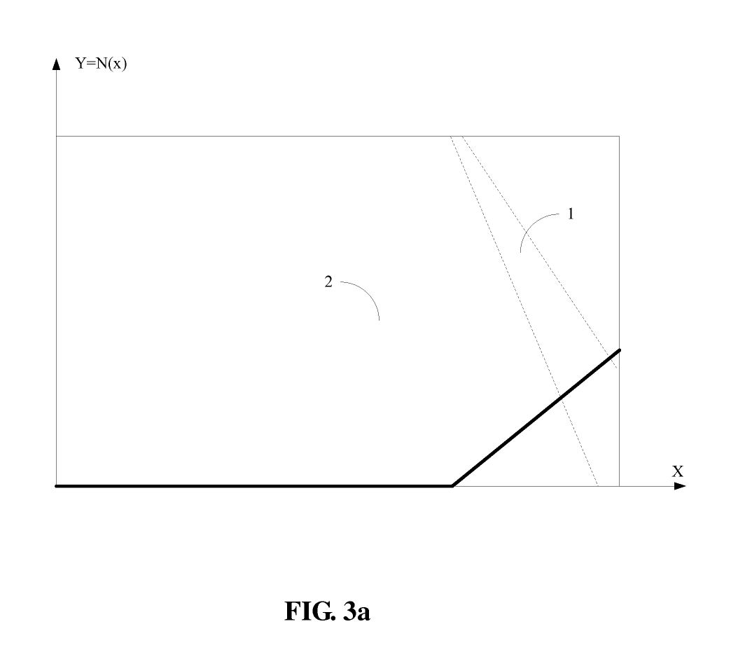

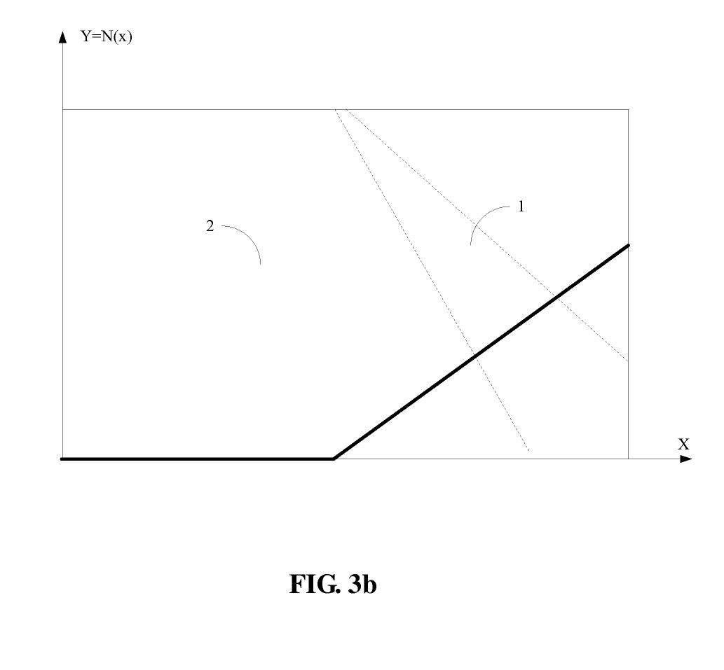

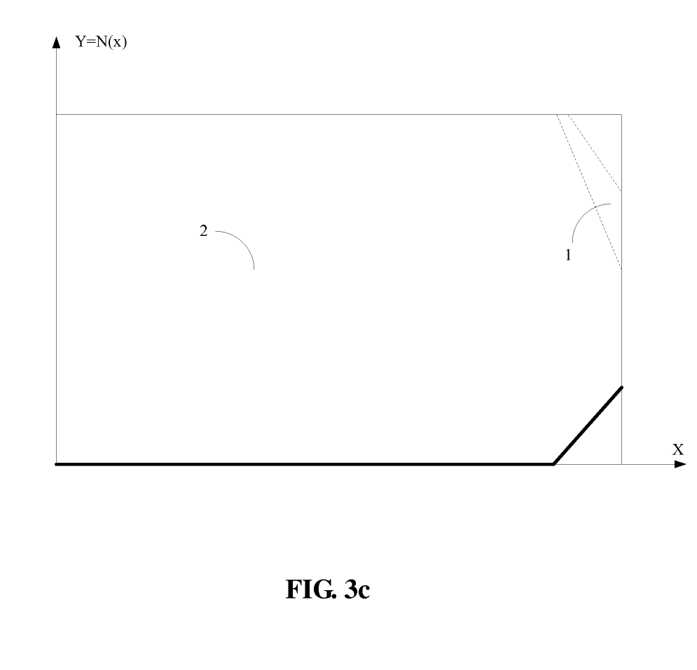

Another embodiment of the present invention to determine the “shifting” of the light-colored block is illustrated in FIGS. 3a˜3c. In the present embodiment, the lateral and vertical directions of each image are assumed to the X axis and Y axis of a coordinate system, respectively. Then, for each x (i.e., a lateral location), the number of light-colored pixels along the Y-axis (i.e., the number of light-colored pixels in the vertical direction) N(x) is counted. FIG. 3a, 3b, 3c show the N(x) curves (denoted by the thicker line) for the images of FIG. 2a, 2b, 2c, respectively. As illustrated, when the motor vehicle deviates to its left or right side, the turning point of the N(x) curve's X coordinate (X_{corner}) (i.e., the lateral location where light-colored pixels in the vertical direction start to manifest) shifts to the right (i.e., X_{corner} increases) or to the left (i.e., X_{corner} decreases). Again, by identifying such a trend and whether the trend has reached a terminal condition, a deviation of the motor vehicle to cross its traveling lane could be determined. Exemplary terminal conditions for the present embodiment could be (X_{corner}≦T_{L}) and (X_{corner}≧T_{R}) for potential crossing right lane marker and left lane marker, respectively.

To sum up, despite various embodiments of the present invention, the main idea of the present invention is to base its judgment of the motor vehicle's deviation on the lateral distribution of the light-colored pixels. The terminal condition, in addition to be related to the lateral distribution of the light-colored pixels in the images, could incorporate factors related to the various conditions of the motor vehicle. These factors include, but are not limited to, speed of the motor vehicle (e.g., if the speed is zero or decreasing, there is no point to identify whether it is deviating, as the motor vehicle is still or about to stop), whether a direction light at the same side of the deviation is turned on (e.g., if it is turned on, then the motor vehicle is turning), and whether one or more of these states last for a period time or for a number of consecutive images (so as to ignore transient phenomenon), etc.

Subsequently, when a terminal condition is satisfied, the present method produces at least an audible signal to alert the driver. The audible signal could be a siren or a pre-recorded voice message. The audible signal is usually presented by an alarming device such as a speaker, which could be one of the motor vehicle's stereo system or a separate one. Additionally, the present method could further provide a visual alarm such flashing light or text on the motor vehicle's dash board, rear-view mirror, windshield (by projection) or on a separate display device. After the terminal condition is no longer satisfied, the present method automatically stops the production of the audible or visual alarm.

Please note that the image capturing device 100 could also be installed on the head portion of the motor vehicle 10 in front of the left front wheel's tire 20. An image obtained by the image capturing device 100 would be similar to the one shown in FIG. 1b but laterally reversed. The determination of deviation and lane crossing could be conducted in similar ways by extending the foregoing description. Their details are therefore omitted here.

In an alternative embodiment, two image capturing devices 100 are installed on the head portion of the motor vehicle 10 in front of the left and right wheels' tires 20, respectively. The present method then processes the images obtained by the two image capturing devices 100 simultaneously but separately. The present method then combines the two judgments derived from the two steams of images in making a final judgment. This is a relatively costly approach but the chance of misjudgment is reduced. For example, the present method will trigger an alarm only when both steams of images manifest deviations to the same side.

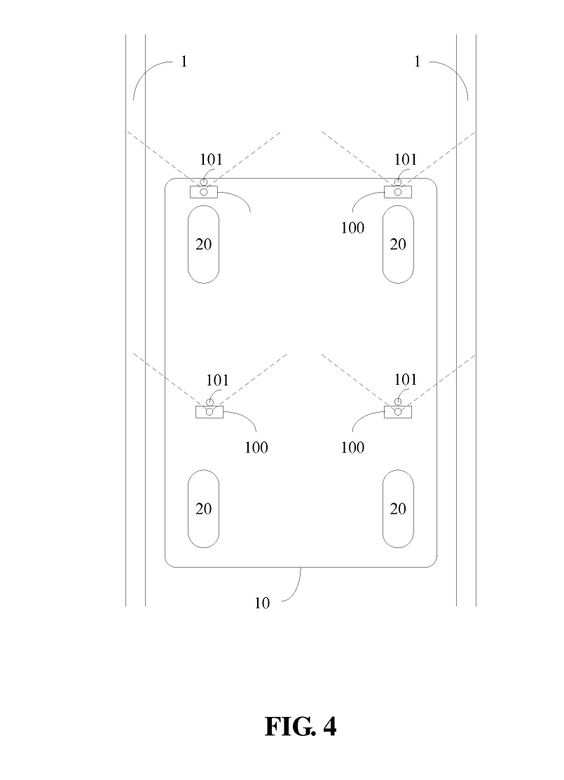

FIG. 4 shows other possible embodiments of the installation of the image capturing device 100. As illustrated, the image capturing device 100 is installed on a bottomcarriage of the motor vehicle 10. There are four possible locations: in front of the left and right front wheels' tires 20, and in front of the left and right rear wheels' tires 20. The image capturing device 100 could be installed at one of the spots, or all four spots have their respective image capturing devices 100, respectively. Regardless of its location, the image capturing device 100 should be installed so that the light-colored block representing the lane marker 1 appears only in a lateral portion of the captured image.

To prevent misjudgment from insufficient lighting during the night or in rainy days, an illumination unit 101 (e.g., a lamp or a light emitting diode) could be provided on or adjacent to the image capturing device 100 to provide auxiliary lighting. The projection of the illumination unit 101's light should substantially conform to the image capturing device 100's field of view.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of detecting and signaling deviation of a motor vehicle, comprising the steps of:
providing at least an image capturing which is installed on a head portion of said motor vehicle substantially in front of a side's front wheel so that images obtained by said image capturing device contain dark-colored road paving and a light-colored lane mark along said side of said motor vehicle, and said light-color lane mark appears within said side of said images;
for each image obtained by said image capturing device, obtaining a lateral distribution of light-colored pixels; and
when a terminal condition is satisfied, providing at least an audible signal and, when subsequently said terminal condition is not satisfied, ceasing to provide said audible signal;
wherein said terminal condition is at least related to said distribution's shifting toward said side or the other side up to an appropriate degree.

2. The method according to claim 1, wherein said lateral distribution is the densities of light-colored pixels of a plurality of laterally partitioned regions of an image obtained by said image capturing device.

3. The method according to claim 1, wherein said lateral distribution is the numbers of light-colored pixels along a vertical direction of all lateral locations of an image obtained by said image capturing device.

4. The method according to claim 1, wherein said terminal condition is further related to at least one of a speed of said motor vehicle and a direction light's turning on or off at said side of said motor vehicle.

5. The method according to claim 1, further comprising the step of:
when said terminal condition is satisfied, providing at least a visual signal and, when subsequently said terminal condition is not satisfied, ceasing to provide said visual signal.

6. A method of detecting and signaling deviation of a motor vehicle, comprising the steps of:
providing at least an image capturing which is installed on a bottomcarriage along a side of said motor vehicle so that images obtained by said image capturing device contain dark-colored road paving and a light-colored lane mark along said side of said motor vehicle, and said light-color lane mark appears within said side of said images;
for each image obtained by said image capturing device, obtaining a lateral distribution of light-colored pixels; and
when a terminal condition is satisfied, providing at least an audible signal and, when subsequently said terminal condition is not satisfied, ceasing to provide said audible signal;
wherein said terminal condition is at least related to said distribution's shifting toward said side or the other side up to an appropriate degree.

7. The method according to claim 6, wherein said image capturing device is installed in front of left front wheel, right front wheel, left rear wheel, or right rear wheel.

8. The method according to claim 6, further comprising the step of:
providing at least an illumination unit whose projection substantially conforms to a field of view of said image capturing device.

9. The method according to claim 6, wherein said lateral distribution is the densities of light-colored pixels of a plurality of laterally partitioned regions of an image obtained by said image capturing device.

10. The method according to claim 1, wherein said lateral distribution is the numbers of light-colored pixels along a vertical direction of all lateral locations of an image obtained by said image capturing device.

11. The method according to claim 1, wherein said terminal condition is further related to at least one of a speed of said motor vehicle and a direction light's turning on or off at said side of said motor vehicle.

12. The method according to claim 1, further comprising the step of:
when said terminal condition is satisfied, providing at least a visual signal and, when subsequently said terminal condition is not satisfied, ceasing to provide said visual signal.
